(19) United States
(12) Patent Application Publication
(10) Pub. No.: US 2013/0135873 A1
(43) Pub. Date: May 30, 2013

(54) ILLUMINATION LAMP HAVING A LIGHT-PROJECTING ANGLE ADJUSTING FUNCTION

(71) Applicants: HUNG-HSIN LEE, TAIPEI CITY (TW); YEN-FU LIU, NEW TAIPEI CITY (TW); CHIH YUAN HUANG, NEW TAIPEI CITY (TW)

(72) Inventors: HUNG-HSIN LEE, TAIPEI CITY (TW); YEN-FU LIU, NEW TAIPEI CITY (TW); CHIH YUAN HUANG, NEW TAIPEI CITY (TW)

(73) Assignee: ENERGYLED CORPORATION, NEW TAIPEI CITY (TW)

(21) Appl. No.: 13/444,885

(22) Filed: Apr. 12, 2012

(30) Foreign Application Priority Data
Nov. 30, 2011 (TW) 100143919

(51) Int. Cl. F21V 29/00; F21V 19/02; F21V 1/00; F21V 15/04; F21V 21/06

(52) U.S. Cl. 362/294; 362/390; 362/418

(57) ABSTRACT

An illumination lamp having a light-projecting angle adjusting function includes: a base unit, a light-emitting unit and a retaining unit. The base unit includes a retaining module, and the retaining module has a plurality of retaining grooves arranged as a surrounding shape and a surrounding receiving groove. The light-emitting unit is disposed on the base unit. The retaining unit includes a movable retaining element penetrating through the light-emitting unit and moved along with the light-emitting unit. In addition, the movable retaining element has a first end portion and a second end portion corresponding with each other, and the first end portion selectively positioned in one of the retaining grooves for positioning the light-emitting unit or movably disposed in the surrounding receiving groove for rotating the light-emitting unit.

### BACKGROUND OF THE INVENTION

1. Field of the Invention

The instant disclosure relates to an illumination lamp, and more particularly, to an illumination lamp having a light-projecting angle adjusting function.

2. Description of Related Art

Compared to the newly developed light-emitting-diode (LED) lamps, these traditional lamps have the disadvantages of quick attenuation, high power consumption, high heat generation, short service life, high fragility, and being not recyclable. Thus, various high-powered LED structures are created to replace the traditional light sources.

However, conventional LED lamp bulbs suffer some drawbacks. For one thing, the light-projecting angle of the conventional LED lamp bulb is fixed and cannot be adjusted, thus the conventional LED lamp bulb is unable to provide adjustability for proper correction. Therefore, the light-projecting angle of the prior art LED lamp bulbs cannot be corrected and cannot be adjusted according to the different requirements.

### SUMMARY OF THE INVENTION

One aspect of the instant disclosure relates to an illumination lamp having a light-projecting angle adjusting function, thus the light-projecting angle of the illumination lamp can be adjusted according to the different requirements.

One of the embodiments of the instant disclosure provides an illumination lamp having a light-projecting angle adjusting function, comprising: a base unit, a light-emitting unit, a retaining unit and a pressing unit. The base unit includes a base body, an electrical connection element disposed on the bottom portion of the base body, and a retaining module disposed on the top portion of the base body, wherein the retaining module has a plurality of retaining grooves arranged as a surrounding shape and a surrounding receiving groove communicated with the retaining grooves and formed under the retaining grooves. The light-emitting unit is disposed on the base unit and electrically connected to the electrical connection element. The retaining unit includes a movable retaining element penetrating through the light-emitting unit and moved along with the light-emitting unit, wherein the movable retaining element has a first end portion and a second end portion corresponding with each other, and the first end portion selectively positioned in one of the retaining grooves for positioning the light-emitting unit or movably disposed in the surrounding receiving groove for rotating the light-emitting unit. The pressing unit includes a pressing element and an elastic element abutted against the bottom portion of the pressing element, wherein the pressing element has a pressing portion exposed outwardly from the light-emitting unit, and the second end portion of the movable retaining element passes through the elastic element to connect with the bottom portion of the pressing element.

Another one of the embodiments of the instant disclosure provides an illumination lamp having a light-projecting angle adjusting function, comprising: a base unit, a light-emitting unit and a retaining unit. The base unit includes a retaining module, wherein the retaining module has a plurality of retaining grooves arranged as a surrounding shape and a surrounding receiving groove. The light-emitting unit is disposed on the base unit. The retaining unit includes a movable retaining element penetrating through the light-emitting unit and moved along with the light-emitting unit, wherein the movable retaining element has a first end portion and a second end portion corresponding with each other, and the first end portion selectively positioned in one of the retaining grooves for positioning the light-emitting unit or movably disposed in the surrounding receiving groove for rotating the light-emitting unit.

Therefore, the first end portion of the movable retaining element can be selectively positioned in one of the retaining grooves for positioning the light-emitting unit or movably disposed in the surrounding receiving groove for rotating the light-emitting unit, thus the light-projecting angle of the illumination lamp can be adjusted freely according to the different requirements.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1 shows a perspective, exploded, schematic view of the illumination lamp according to the instant disclosure;

FIG. 2 shows another perspective, exploded, schematic view of the illumination lamp according to the instant disclosure;

FIG. 3 shows a perspective, schematic view of the retaining module of the illumination lamp according to the instant disclosure;

FIG. 4 shows a perspective, assembled, schematic view of the illumination lamp according to the instant disclosure;

FIG. 5 shows a partial, cross-sectional, schematic view of the illumination lamp having been released for rotating the light-projecting angle according to the instant disclosure; and

FIG. 6 shows a partial, cross-sectional, schematic view of the illumination lamp having been locked for fixing the light-projecting angle according to the instant disclosure.

### DETAILED DESCRIPTION OF THE PREFERRED EMBODIMENTS

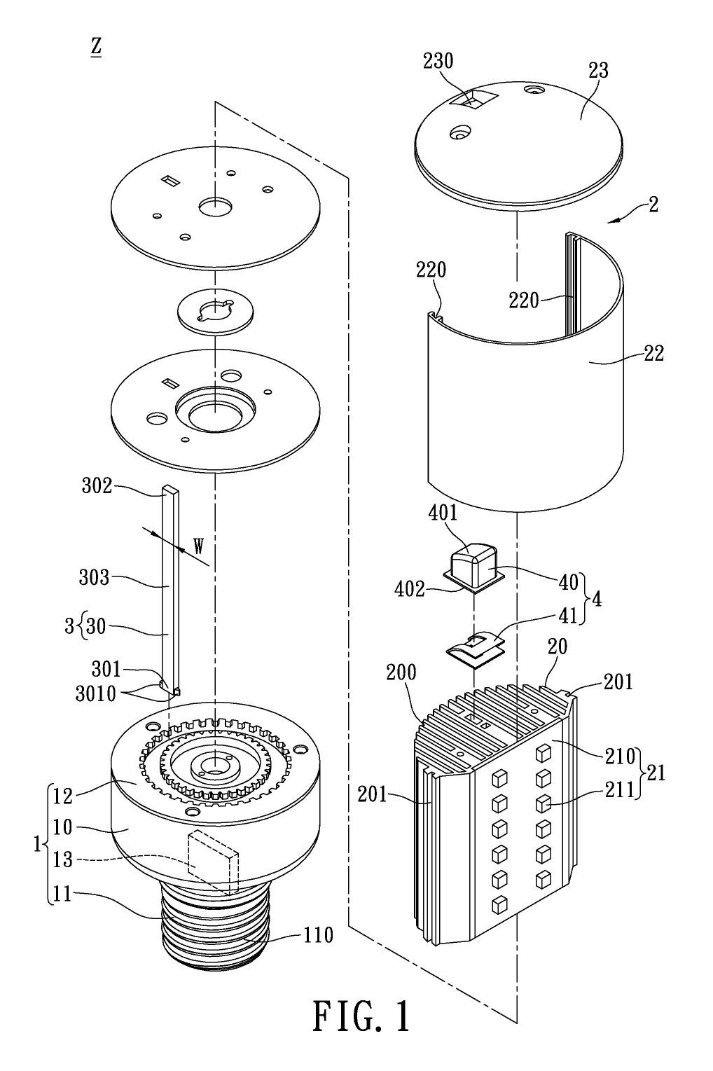

Referring to FIG. 1 to FIG. 4, where the instant disclosure provides an illumination lamp Z having a light-projecting angle adjusting function, comprising: a base unit 1, a light-emitting unit 2, a retaining unit 3 and a pressing unit 4.

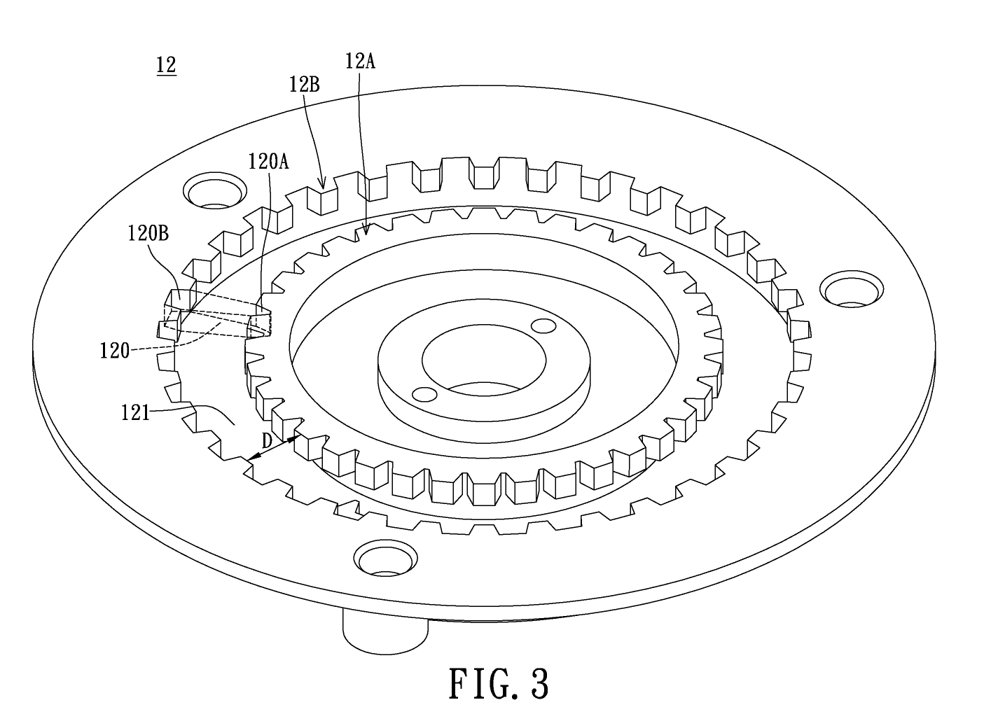

Referring to FIG. 1 to FIG. 3, the base unit 1 includes a base body 10, an electrical connection element 11 disposed on the bottom portion of the base body 10, and a retaining module 12 disposed on the top portion of the base body 10. The retaining module 12 has a plurality of retaining grooves 120 (as shown in FIG. 3) arranged as a surrounding shape and a surrounding receiving groove 121 communicated with the retaining grooves 120 and formed under the retaining grooves 120 (as shown in FIG. 3).

For example, the electrical connection element 11 may be an electrical connector having a securing screw 110 formed on the external surrounding surface of the electrical connector, thus the electrical connection element 11 of the illumination lamp Z can be positioned in a power socket (not shown) by rotating to obtain power supply. In addition, the base unit 1 includes a drive IC module 13 electrically connected between the electrical connection element 11 and the light-emitting unit 2 in order to transform voltage from AC (alternating current) into DC (Direct current), thus the instant disclosure can provide DC for the light-emitting unit 2.

For example, referring to FIG. 3, the retaining module 12 includes a first gear structure 12A (such as an outer gear structure) and a second gear structure 12B (such as an inner gear structure surrounding the outer gear structure) surrounding the first gear structure 12A. The first gear structure 12A has a plurality of first grooves 120A arranged as a surrounding shape, the second gear structure 12B has a plurality of second grooves 120B arranged as a surrounding shape and respectively facing the first grooves 120A. In addition, each retaining groove 120 can be connected between each corresponding first groove 120A and each corresponding second groove 120B that face each other. In other words, because the first grooves 120A respectively correspond to the second grooves 120B, a retaining groove 120 can be formed between each corresponding first groove 120A and each corresponding second groove 120B that face each other. Each retaining groove 120 is composed of the first space occupied by the first groove 120A, the second space occupied by the second groove 120B, and the third space between the first groove 120A and the second groove 120B. The minimum light-projecting angle of the illumination lamp Z can be determined by the number of the retaining grooves 120. However, the retained module 12 used in the instant disclosure is merely an example and is not meant to limit the instant disclosure.

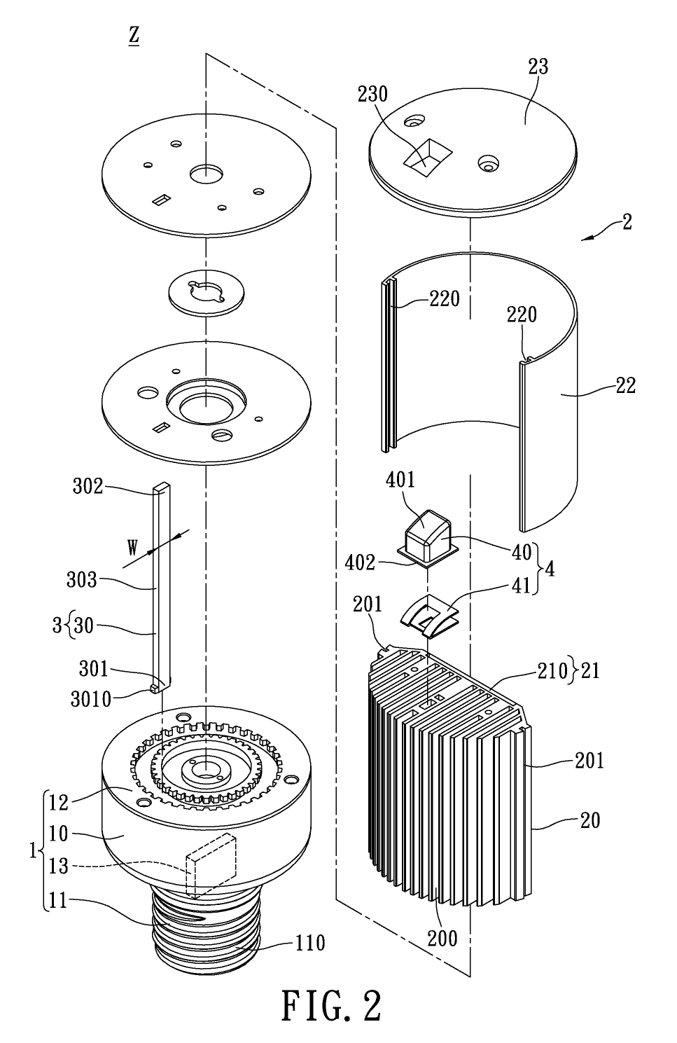

Referring to FIG. 1 and FIG. 2, the light-emitting unit 2 is disposed on the base unit 1 and electrically connected to the electrical connection element 11. For example, the light-emitting unit 2 includes a heat-dissipating body 20, a light-emitting module 21 disposed on the heat-dissipating body 20 and electrically connected to the electrical connection element 11, a light-transmitting lampshade 22 disposed on the heat-dissipating body 20 to cover the light-emitting module 21, and a lateral cover 23 disposed on the top portion of the light-emitting unit 2.

For example, the heat-dissipating body 20 has a plurality of heat-dissipating fins 200 disposed on the bottom portion thereof and extended downwardly. The light-emitting module 21 includes a circuit substrate 210 and a plurality of light-emitting elements 211 disposed on the circuit substrate 210 and electrically connected to the circuit substrate 210, and each light-emitting element 211 may be composed of at least one LED chip (such as a blue LED chip for generating blue light beams) and a package colloid body (such as a phosphor colloid body) for covering the LED chip. In addition, the light-transmitting lampshade 22 can be formed as an arch shape and includes a plurality of diffusion particles mixed inside the light-transmitting lampshade 22 in order to increase light-emitting efficiency. The light-transmitting lampshade 22 has two first retaining structures 220 respectively disposed on two opposite lateral sides thereof, and the heat-dissipating body 20 has two second retaining structures 201 respectively disposed on two opposite lateral sides thereof. The two retaining structures 220 can be respectively mated with the two second retaining structures 201, thus the two opposite lateral sides of the light-transmitting lampshade 22 can be respectively retained with the two opposite lateral sides of the heat-dissipating body 20. However, the light-emitting unit 2 used in the instant disclosure is merely an example and is not meant to limit the instant disclosure.

Referring to FIG. 1 to FIG. 3, the retaining unit 3 includes a movable retaining element 30 penetrating through the light-emitting unit 2 and moved along with the light-emitting unit 2. The movable retaining element 30 has a first end portion 301 and a second end portion 302 corresponding with each other, the movable retaining element 30 has a main body 303 connected between the first end portion 301 and the second end portion 302, and the first end portion 301 of the movable retaining element 30 can be selectively positioned in one of the retaining grooves 120 for positioning the light-emitting unit 2 or movably disposed in the surrounding receiving groove 121 for rotating the light-emitting unit 2.

For example, the first end portion 301 of the movable retaining element 30 has two retaining blocks 3010 corresponding to each other, and the two retaining blocks 3010 can be respectively retained in the corresponding first groove 120A and the corresponding second groove 120B that face each other. In other words, the first end portion 301 of the movable retaining element 30 can be received in the corresponding retaining groove 120 and between the corresponding first groove 120A and the corresponding second groove 120B that face each other, thus the light-emitting unit 2 is positioned and the light-projecting angle of the illumination lamp Z cannot be adjusted. Furthermore, the main body 303 has a maximum width W smaller than a minimum distance D between the first gear structure 12A and the second gear structure 12B, thus the main body 303 of the movable retaining element 30 can easily pass through the first gear structure 12A and the second gear structure 12B for moving freely the first end portion 301 of the movable retaining element 30 in the surrounding receiving groove 121, and the light-emitting unit 2 is released at the same time for adjusting the light-projecting angle of the illumination lamp Z. However, the movable retaining element 30 used in the instant disclosure is merely an example and is not meant to limit the instant disclosure.

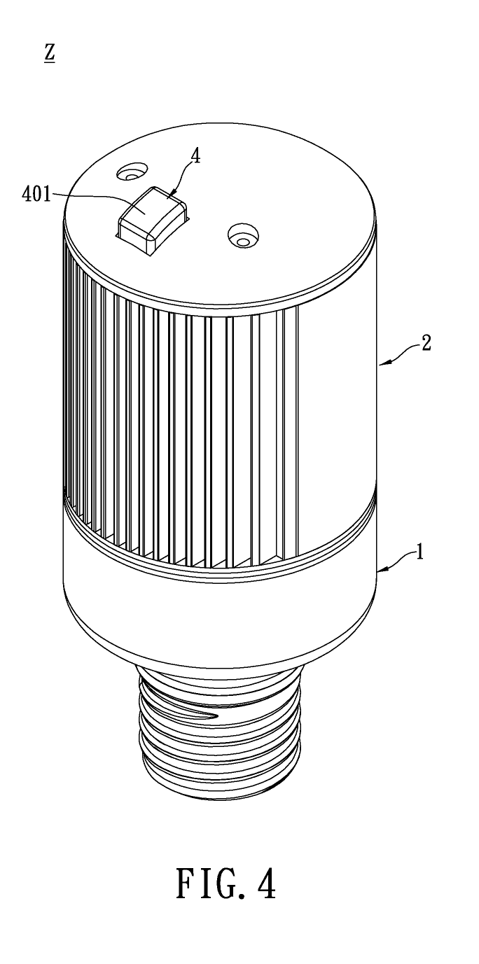

Referring to FIG. 1, FIG. 2 and FIG. 4, the pressing unit 4 includes a pressing element 40 and an elastic element 41 abutted against the bottom portion of the pressing element 40. In addition, the pressing element 40 has a pressing portion 401 exposed outwardly from the light-emitting unit 2, and the second end portion 302 of the movable retaining element 30 passes through the elastic element 41 to connect with the bottom portion of the pressing element 40, thus the movable retaining element 30 can sequentially pass through the heat-dissipating body 20 and the elastic element 41.

For example, because the lateral cover 23 has a through opening 230, the pressing portion 401 can pass through the through opening 230. The pressing element 40 has a position-limiting portion 402 disposed under the pressing portion 401 and contacting the bottom portion of the lateral cover 23, thus the pressing portion 401 can pass through the through opening 230, but the pressing element 40 cannot be escaped from the lateral cover 23. In addition, the second end portion 302 of the movable retaining element 30 can be connected to the position-limiting portion 402, for example, the second end portion 302 can be embedded into the position-limiting portion 402 and combined with the position-limiting portion 402. Furthermore, the elastic element 41 can be disposed between the position-limiting portion 402 and the heat-dissipating body 20, and the elastic element 41 may be an elastic piece or spring, thus the position-limiting portion 402 of the pressing element 40 can continuously abut against the bottom portion of the lateral cover 23. Such as the elastic piece, the elastic element 41 has a plane base portion (not labeled) disposed on the heat-dissipating body 20 and an elastic portion (not labeled) extended upwardly and obliquely from the plane base portion to continuously abut against the bottom portion of the position-limiting portion 402. The plane base portion has a first opening, the elastic portion has a second opening corresponding to the first opening, thus the second end portion 302 of the movable retaining element 30 can respectively pass through the first opening the second opening of the elastic element 40 to contact the bottom portion of the pressing element 40. However, the elastic element 40 or the elastic element 41 used in the instant disclosure is merely an example and is not meant to limit the instant disclosure.

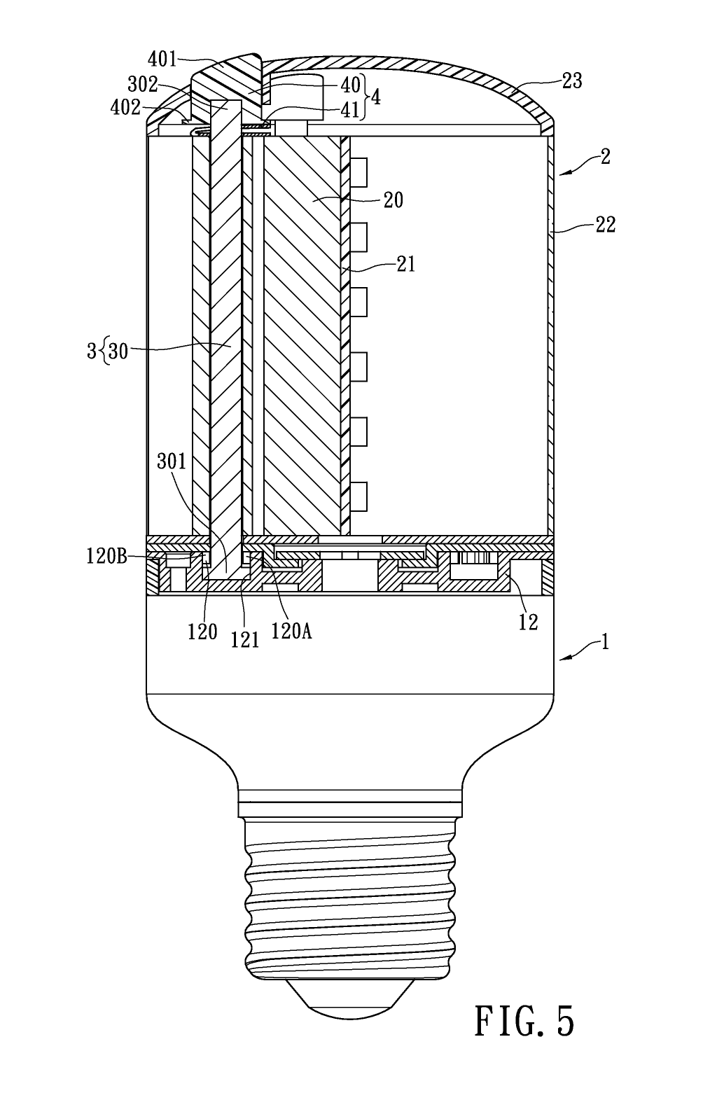

Moreover, referring to FIG. 3 and FIG. 5, when the pressing portion 401 is pressed, the elastic element 41 can be pressed by the pressing portion 40 to move the first end portion 301 of the movable retaining element 30 from the retaining groove 120 to the surrounding receiving groove 121. In other words, the maximum width W of the main body 303 is smaller than the minimum distance D between the first gear structure 12A and the second gear structure 12B, thus the main body 303 of the movable retaining element 30 can easily pass through the first gear structure 12A and the second gear structure 12B for moving freely the first end portion 301 of the movable retaining element 30 in the surrounding receiving groove 121, and the light-emitting unit 2 is released at the same time for adjusting the light-projecting angle of the illumination lamp Z.

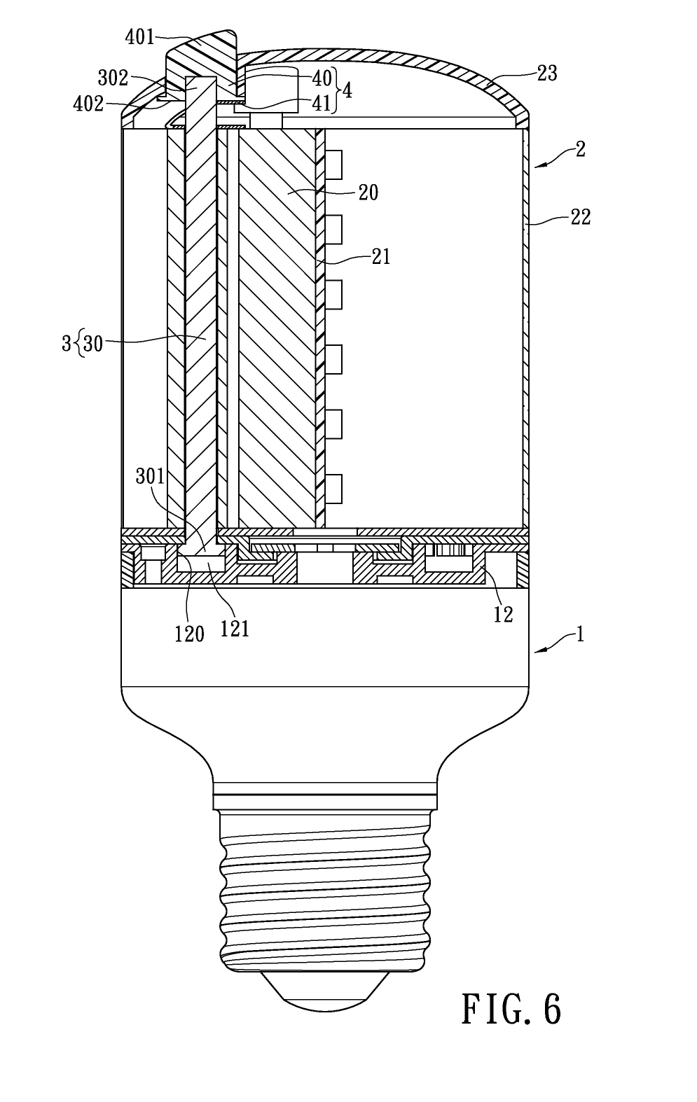

Furthermore, referring to FIG. 3 and FIG. 6, when the pressing portion 401 is released, the elastic element 41 can be released by the pressing portion 40 to move the first end portion 301 of the movable retaining element 30 to come back from the surrounding receiving groove 121 to the retaining groove 120. In other words, when the first end portion 301 of the movable retaining element 30 has two retaining blocks 3010 corresponding to each other and the two retaining blocks 3010 can be respectively retained in the corresponding first groove 120A and the corresponding second groove 120B that face each other, the first end portion 301 of the movable retaining element 30 can be received in the corresponding retaining groove 120 and between the corresponding first groove 120A and the corresponding second groove 120B that face each other, thus the light-emitting unit 2 is positioned and the light-projecting angle of the illumination lamp Z cannot be adjusted.

In conclusion, the first end portion 301 of the movable retaining element 30 can be selectively positioned in one of the retaining grooves 120 for positioning the light-emitting unit 2 or movably disposed in the surrounding receiving groove 121 for rotating the light-emitting unit 2, thus the light-projecting angle of the illumination lamp Z can be adjusted freely according to the different requirements.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. An illumination lamp having a light-projecting angle adjusting function, comprising:
a base unit including a base body, an electrical connection element disposed on the bottom portion of the base body, and a retaining module disposed on the top portion of the base body, wherein the retaining module has a plurality of retaining grooves arranged as a surrounding shape and a surrounding receiving groove communicated with the retaining grooves and formed under the retaining grooves;
a light-emitting unit disposed on the base unit and electrically connected to the electrical connection element;
a retaining unit including a movable retaining element penetrating through the light-emitting unit and moved along with the light-emitting unit, wherein the movable retaining element has a first end portion and a second end portion corresponding with each other, and the first end portion selectively positioned in one of the retaining grooves for positioning the light-emitting unit or movably disposed in the surrounding receiving groove for rotating the light-emitting unit; and
a pressing unit including a pressing element and an elastic element abutted against the bottom portion of the pressing element, wherein the pressing element has a pressing portion exposed outwardly from the light-emitting unit, and the second end portion of the movable retaining element passes through the elastic element to connect with the bottom portion of the pressing element.

2. The illumination lamp of claim 1, wherein the retaining module includes a first gear structure and a second gear structure surrounding the first gear structure, the first gear structure has a plurality of first grooves arranged as a surrounding shape, the second gear structure has a plurality of second grooves arranged as a surrounding shape and respectively facing the first grooves, and each retaining groove is connected between each corresponding first groove and each corresponding second groove.

3. The illumination lamp of claim 2, wherein the first end portion of the movable retaining element has two retaining blocks corresponding to each other, and the two retaining blocks are respectively retained in the corresponding first groove and the corresponding second groove that face each other.

4. The illumination lamp of claim 2, wherein the movable retaining element has a main body connected between the first end portion and the second end portion, and the main body has a maximum width smaller than a minimum distance between the first gear structure and the second gear structure.

5. The illumination lamp of claim 1, wherein the light-emitting unit includes a heat-dissipating body, a light-emitting module disposed on the heat-dissipating body and electrically connected to the electrical connection element, a light-transmitting lampshade disposed on the heat-dissipating body to cover the light-emitting module, and a lateral cover disposed on the top portion of the light-emitting unit, and the movable retaining element sequentially passes through the heat-dissipating body and the elastic element.

6. The illumination lamp of claim 5, wherein the heat-dissipating body has a plurality of heat-dissipating fins disposed on the bottom portion thereof and extended downwardly, the light-emitting module includes a circuit substrate and a plurality of light-emitting elements disposed on the circuit substrate and electrically connected to the circuit substrate, and the light-transmitting lampshade has two opposite lateral sides respectively retained with two opposite lateral sides of the heat-dissipating body.

7. The illumination lamp of claim 5, wherein the lateral cover has a through opening, the pressing portion passes through the through opening, the pressing element has a position-limiting portion disposed under the pressing portion and contacting the bottom portion of the lateral cover, the second end portion of the movable retaining element is connected to the position-limiting portion, and the elastic element is disposed between the position-limiting portion and the heat-dissipating body.

8. The illumination lamp of claim 1, wherein when the pressing portion is pressed, the elastic element is pressed by the pressing portion to move the first end portion of the movable retaining element from the retaining groove to the surrounding receiving groove.

9. The illumination lamp of claim 8, wherein when the pressing portion is released, the elastic element is released by the pressing portion to move the first end portion of the movable retaining element from the surrounding receiving groove to the retaining groove.

10. An illumination lamp having a light-projecting angle adjusting function, comprising:
a base unit including a retaining module, wherein the retaining module has a plurality of retaining grooves arranged as a surrounding shape and a surrounding receiving groove;
a light-emitting unit disposed on the base unit; and
a retaining unit including a movable retaining element penetrating through the light-emitting unit and moved along with the light-emitting unit, wherein the movable retaining element has a first end portion and a second end portion corresponding with each other, and the first end portion selectively positioned in one of the retaining grooves for positioning the light-emitting unit or movably disposed in the surrounding receiving groove for rotating the light-emitting unit.

11. The illumination lamp of claim 10, wherein the retaining module includes a first gear structure and a second gear structure surrounding the first gear structure, the first gear structure has a plurality of first grooves arranged as a surrounding shape, the second gear structure has a plurality of second grooves arranged as a surrounding shape and respectively facing the first grooves, and each retaining groove is connected between each corresponding first groove and each corresponding second groove.

12. The illumination lamp of claim 11, wherein the first end portion of the movable retaining element has two retaining blocks corresponding to each other, and the two retaining blocks are respectively retained in the corresponding first groove and the corresponding second groove that face each other.

13. The illumination lamp of claim 11, wherein the movable retaining element has a main body connected between the first end portion and the second end portion, and the main body has a maximum width smaller than a minimum distance between the first gear structure and the second gear structure.

14. The illumination lamp of claim 10, further comprising: a pressing unit including a pressing element and an elastic element abutted against the bottom portion of the pressing element, wherein the pressing element has a pressing portion exposed outwardly from the light-emitting unit, and the second end portion of the movable retaining element passes through the elastic element to connect with the bottom portion of the pressing element.

15. The illumination lamp of claim 14, wherein the light-emitting unit includes a heat-dissipating body, a light-emitting module disposed on the heat-dissipating body and electrically connected to the electrical connection element, a light-transmitting lampshade disposed on the heat-dissipating body to cover the light-emitting module, and a lateral cover disposed on the top portion of the light-emitting unit, and the movable retaining element sequentially passes through the heat-dissipating body and the elastic element.

16. The illumination lamp of claim 15, wherein the heat-dissipating body has a plurality of heat-dissipating fins disposed on the bottom portion thereof and extended downwardly, the light-emitting module includes a circuit substrate and a plurality of light-emitting elements disposed on the circuit substrate and electrically connected to the circuit substrate, and the light-transmitting lampshade has two opposite lateral sides respectively retained with two opposite lateral sides of the heat-dissipating body.

17. The illumination lamp of claim 15, wherein the lateral cover has a through opening, the pressing portion passes through the through opening, the pressing element has a position-limiting portion disposed under the pressing portion and contacting the bottom portion of the lateral cover, the second end portion of the movable retaining element is connected to the position-limiting portion, and the elastic element is disposed between the position-limiting portion and the heat-dissipating body.

18. The illumination lamp of claim 14, wherein when the pressing portion is pressed, the elastic element is pressed by the pressing portion to move the first end portion of the movable retaining element from the retaining groove to the surrounding receiving groove.

19. The illumination lamp of claim 18, wherein when the pressing portion is released, the elastic element is released by the pressing portion to move the first end portion of the movable retaining element from the surrounding receiving groove to the retaining groove.
